(19) United States
(12) Patent Application Publication
(10) Pub. No.: US 2018/0246060 A1
(43) Pub. Date: Aug. 30, 2018

(54) ION-MOBILITY SPECTROMETRY DRIFT CELL AND ION-MOBILITY SPECTROMETER

(71) Applicant: Shimadzu Corporation, Kyoto (JP)

(72) Inventor: Yusuke NAGAI, Kyoto (JP)

(73) Assignee: Shimadzu Corporation, Kyoto (JP)

(21) Appl. No.: 15/754,405

(22) PCT Filed: Aug. 24, 2015
(86) PCT No.: PCT/JP2015/073665

§ 371 Date: Feb. 22, 2018

(51) Int. Cl. G01N 27/62

(52) U.S. Cl. CPC G01N 27/622

(57) ABSTRACT

A rectangular cylindrical drift cell is formed by bonding four resistive film layer members in which a resistive film layer having a uniform film thickness is formed on a surface of a plate member formed of an insulator of alumina or the like through a coating method or a vapor deposition. A predetermined voltage is applied from a drift voltage generator to the resistive film layers of both ends of the drift cell so that an accelerating electric field having a linear potential gradient is formed along a center axis (C) in a desolvation region and a drift region inside the drift cell. Ions are drifted by the accelerating electric field and are separated in response to the ion mobility.

### TECHNICAL FIELD

The present invention relates to an ion mobility analyzer which separates and detects ions in response to mobility or separates ions and sends the ions to a subsequent mass spectrometer or the like and a drift cell used in the ion mobility analyzer to separate ions.

### BACKGROUND ART

When molecular ions generated from a sample molecule are moved in a medium gas (or a liquid) by the action of an electric field, the ions move at a speed proportional to the mobility determined by the strength of the electric field, the size of the molecule, and the like. Ion mobility spectrometry (IMS) is a measurement method using this mobility to analyze sample molecules. FIG. 8 is a schematic configuration diagram of a general ion mobility analyzer of the related art (see Patent Document 1 and the like).

The ion mobility analyzer includes an ion source 1 which ionizes component molecules in a liquid sample by an electrospray ionization (ESI) method or the like, a cylindrical drift cell 9 which has a desolvation region 2 and a drift region 3 formed therein, and a detector 5 which detects ions moved in the drift region 3. Further, a shutter gate 4 is provided at an entrance of the drift region 3 in order to send ions generated in the ion source 1 from the desolvation region 2 to the drift region 3 in a pulse manner within a very short time width. An atmosphere or a low-vacuum atmosphere of about 100 [Pa] is formed inside the drift cell 9 and a descending potential gradient is formed, that is, a uniform electric field for accelerating the ions is formed in an ion movement direction (a Z direction in FIG. 8) in the desolvation region 2 and the drift region 3 by a DC voltage applied to each of a plurality of annular electrodes 91 disposed inside the drift cell 9. Further, a neutral diffusion gas flow is formed in a direction opposite to the acceleration direction inside the drift cell 9 by this electric field.

The schematic operation of the ion mobility analyzer is as follows.

That is, various ions generated from a sample in the ion source 1 travel in the desolvation region 2 and are temporarily blocked by the shutter gate 4. Then, when the shutter gate 4 is opened only for a short time, the ions are guided into the drift region 3 in packets. In addition, the desolvation region 2 is a region for promoting the generation of ions by promoting the vaporization of the solvent in the charged droplets in which the solvent is not sufficiently vaporized in the ion source 1. The ions guided to the drift region 3 travels by the action of an accelerating electric field while colliding with a diffusion gas flowing thereto. The ions are spatially separated in the Z direction due to their ion mobility depending on the size, three-dimensional structure, electric charge, and the like and the ions having different ion mobilities reach the detector 5 with a time difference. When the electric field in the drift region 3 is uniform, the collision cross-sectional area between the ions and the diffusion gas can be estimated from the drift time necessary for the passage of the ions in the drift region 3.

Instead of directly detecting ions after separating ions in response to the ion mobility as described above, there is also known a configuration in which these ions are guided to a mass separator such as a quadrupole mass filter and the ions are further separated in response to a mass-to-charge ratio and are then detected. Such a device is known as an ion mobility-mass spectrometer (IMS-MS).

As described above, in the ion mobility analyzer of the related art, in order to form the accelerating electric field for moving the ions in the drift cell 9, a structure in which a plurality of annular electrodes 91 are laminated and generally a structure in which annular insulation spacers like annular electrodes are alternately laminated are used. In order to improve the analysis accuracy or resolution in the ion mobility analyzer, there is a need to improve the uniformity of the accelerating electric field, that is, the linearity of the potential gradient on the ion optical axis C. For this configuration, there is a need to narrow a gap between the adjacent annular electrodes 91 as much as possible and to increase the length of the drift region 3 as much as possible. However, in this case, the number of components including the annular electrodes and the insulation spacers increases and the cost increases. Further, since a high skill is required depending on the assembly operation in accordance with an increase in the number of assembly processes, these factors also cause an increase in cost.

Meanwhile, in order to form the electric field having the highly linear potential gradient on the ion optical axis C, there is known an ion mobility analyzer in which a cylindrical glass tube having a resistive coating layer formed on an inner peripheral surface is used as a drift cell (see Patent Documents 2 and 3 and Non-Patent Document 1). In this ion mobility analyzer, it is possible to form an electric field for accelerating ions in the drift cell by applying a predetermined voltage across both ends of the resistive coating layer of the inner peripheral surface of the drift cell.

However, in order to suppress a variation in performance, there is a need to improve the uniformity of the thickness of the resistive coating layer formed on the inner peripheral surface of the cylindrical glass tube, but it requires a high skill when forming the resistive coating layer having a uniform thickness. For that reason, such a drift cell has a small number of components, but the cost is very expensive. Further, since the glass tube can be easily broken, there is a need to pay attention when handling the glass tube. Further, when the lead-doped glass is used as in the drift cell of Non-Patent Document 1, it can be said that the environmental load is high even if the RoHS limit is satisfied.

### CITATION LIST

### Patent Document

Patent Document 1: JP-A-2005-174619

Patent Document 2: U.S. Pat. No. 7,081,618

Patent Document 3: U.S. Pat. No. 8,084,732

### Non-Patent Document

Non-Patent Document 1: “Advanced IMS Analysis with High Resolving Power” [online], Photonis Corporation, USA [Search on Jul. 30, 2015], Internet <URL: http://www.photonis.com/attachment.php?id_attachment=161>

### SUMMARY OF THE INVENTION

### Technical Problem

The invention is made to solve the above-described problems and an object of the invention is to provide an ion mobility analysis drift cell which is low in cost and has small variations in performance such as analysis accuracy and resolution and an ion mobility analyzer using the same.

### Solution to Problem

In order to solve the above-described problems, an ion mobility analysis drift cell according to the invention is an ion mobility analysis drift cell having a drift region, drifting ions by an accelerating electric field, formed therein, in which the drift cell is formed by assembling a plurality of resistive film layer members in a cylindrical shape so that a resistive film layer faces an inner peripheral side using the plurality of resistive film layer members in which the resistive film layer is formed on a surface of an insulation plate member without a cylindrical closed portion.

The ion mobility analyzer contrived to solve the above-described problems is an ion mobility analyzer that uses the ion mobility analysis drift cell according to the invention, including: a) an ion source that generates ions derived from a sample; b) a voltage generator that applies a predetermined voltage to both ends of a resistive film layer of an inner peripheral surface of the drift cell to form an accelerating electric field inside the cylindrical ion mobility analysis drift cell; and c) a shutter gate that is disposed at an ion incident side end portion of the ion mobility analysis drift cell or an inner space of the drift cell and allows the passage of ions generated by the ion source only for a predetermined period to be sent to a drift region where the accelerating electric field is formed inside the drift cell, in which the ion mobility analyzer detects ions separated in response to ion mobility while passing through the drift region inside the ion mobility analysis drift cell or further sends the ions to a subsequent analysis and detection unit.

In the ion mobility analyzer according to the invention, ions separated in response to the ion mobility by the drift in the drift region may be detected by a detector or ions separated in response to the mobility may be guided to, for example, a mass separator or the like separating the ions in response to a mass-to-charge ratio.

In the ion mobility analysis drift cell according to the invention, the insulation plate member without the cylindrical closed portion is typically a flat or curved insulation plate member. The material of the insulation plate member is not particularly limited, but for example, ceramic such as alumina (oxidized aluminum) is preferable. Further, a method of forming the resistive film layer on the surface of the insulation plate member is not particularly limited and various existing methods, for example, a coating method including spraying and rotating, a sputtering method, a vapor deposition method, a chemical method such as a wet process, and the like can be used.

In an aspect of the ion mobility analysis drift cell according to the invention, the drift cell may be formed in a rectangular cylindrical shape or a truncated conical shape by assembling three or more resistive film layer members each forming one surface so that both ends are opened using the three or more resistive film layer members in which a resistive film layer is formed on the entirety or a part of at least one surface of a flat insulation plate member.

Further, in another aspect of the ion mobility analysis drift cell according to the invention, the drift cell may be formed in a cylindrical shape or a truncated conical shape by assembling a plurality of resistive film layer members using the plurality of resistive film layer members in which a resistive film layer is formed on the entirety or a part of at least an inner peripheral surface of a curved insulation plate member having a shape obtained by cutting a cylindrical body or a truncated conical body into a plurality of parts in a plane including an axis thereof.

The ion mobility analysis drift cell according to the invention is not formed by using one cylindrical member as in Patent Documents 2, 3, and the like described above, but is formed by integrally bonding a plurality of resistive film layer members using, for example, an adhesive. Since the base material of the resistive film layer member corresponding to a constituent member is the insulation plate member without the cylindrical closed portion, the resistive film layer can be easily formed on one surface of the member to have a substantially uniform thickness according to the above-described existing methods. Since the resistive film layer member obtained in this way is relatively inexpensive and the process of assembling the member in a cylindrical shape is simple, a cost can be reduced compared to the above-described drift cell of the related art.

Further, when a conductive adhesive is used at the time of using an adhesive for the assembly, it is possible to secure a sufficient electrical connection between the resistive film layers of the plurality of resistive film layer members and to form the cylindrical resistive film layer at the inside of the drift cell.

In the ion mobility analyzer according to the invention, when a predetermined voltage is applied from the voltage generator to both ends of the resistive film layer of the inner peripheral surface of the drift cell, a DC electric field having a potential gradient is formed along the center axis (the ion optical axis) of the drift cell in the drift cell due to a potential difference. When the drift cell has, for example, a rectangular cylindrical shape or the like other than the cylindrical shape, an equipotential line in a plane orthogonal to the center axis does not become a concentric shape at a position close to the inner peripheral surface of the drift cell, but becomes substantially a concentric shape as it becomes closer to the center axis. Further, a potential gradient on the center axis becomes substantially linear. For that reason, a substantially ideal accelerating electric field is formed with respect to the ions moving in the vicinity of the center axis and the ions guided to the drift region having the accelerating electric field formed therein are separated in response to the ion mobility with high accuracy and resolution.

In addition, when there is a potential difference at a circumferential position of the resistive film layer in a plane orthogonal to the center axis, the uniformity of the electric field is degraded. Here, in order to suppress a potential difference due to the circumferential position of the resistive film layer, a conductive portion may be formed at each of both ends of the resistive film layer of the inner peripheral surface of the drift cell and a voltage may be applied from the voltage generator to the conductive portion.

### Advantageous Effects of the Invention

According to the ion mobility analysis drift cell of the invention, since an increase in cost of constituent members can be suppressed and an assembly process is simple, it is possible to obtain an inexpensive drift cell. Further, since the uniformity of the thickness of the resistive film layer for forming the accelerating electric field inside the drift cell is high and the mechanical accuracy at the time of assembling the drift cell can be easily secured, it is also possible to suppress the non-uniformity of performance such as accuracy or resolution. Further, since a high-strength material such as alumina is used as the insulation plate member, the drift cell is not easily broken and thus the drift cell can be easily handled. Furthermore, since lead-doped glass is not used, environmental burden can be suppressed.

Further, according to the ion mobility analyzer of the invention, it is possible to suppress an increase in cost of the ion mobility analyzer itself while securing high analysis accuracy and resolution by using the above-described characteristic drift cell.

### BRIEF DESCRIPTION OF THE DRAWINGS

FIG. 1 is a schematic configuration diagram of an ion mobility analyzer which is an embodiment of the invention.

FIG. 2(a) is a perspective view illustrating a state before a drift cell used in an ion mobility analyzer of the embodiment is assembled and FIG. 2(b) is a perspective view illustrating an assembled state.

FIG. 3(a) is a cross-sectional view taken along a plane orthogonal to a center axis of the drift cell used in the ion mobility analyzer of the embodiment and FIG. 3(b) is an enlarged cross-sectional view.

FIG. 4 is a cross-sectional view illustrating another example of the drift cell.

FIG. 5 is a cross-sectional view illustrating another example of the drift cell.

FIG. 6 is a cross-sectional view illustrating another example of the drift cell.

FIG. 7 is a perspective view illustrating another example of the drift cell.

FIG. 8 is a schematic configuration diagram of a general ion mobility analyzer of the related art.

### MODE FOR CARRYING OUT THE INVENTION

An embodiment of an ion mobility analyzer according to the invention and a drift cell used in the analyzer will be described with reference to the attached drawings.

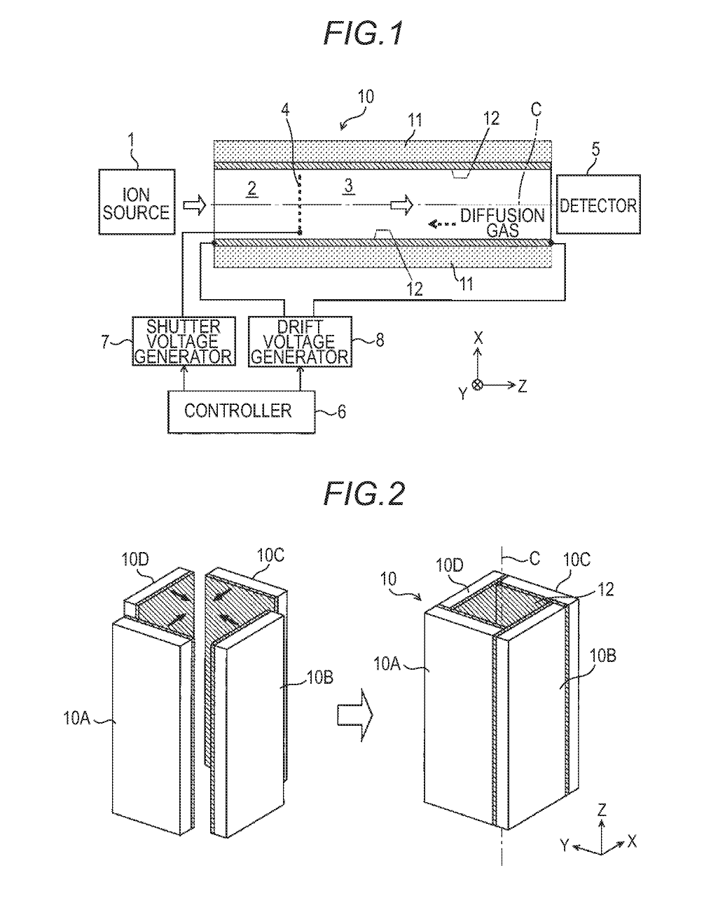

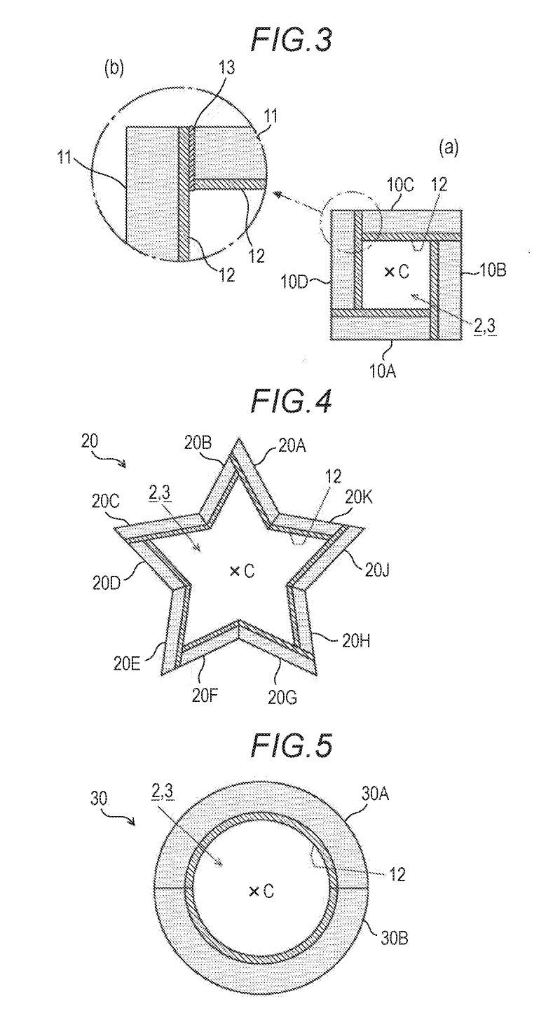

FIG. 1 is a schematic cross-sectional view of the ion mobility analyzer of the embodiment, FIG. 2(a) is a perspective view illustrating a state before the drift cell used in the ion mobility analyzer of the embodiment is assembled, FIG. 2(b) is a perspective view illustrating an assembled state, FIG. 3(a) is a cross-sectional view taken along a plane orthogonal to a center axis of the drift cell, and FIG. 3(b) is an enlarged cross-sectional view. In FIG. 1, the same reference numerals are given to the same or corresponding components as those of the conventional ion mobility analyzer which has been already described with reference to FIG. 8.

In the ion mobility analyzer of the embodiment, a desolvation region 2 and a drift region 3 in which a DC electric field having a linear potential gradient is formed along an ion optical axis (which is also a center axis of a drift cell 10 to be described later) C and a diffusion gas flow is formed are formed inside the rectangular cylindrical drift cell 10.

The drift cell 10 includes four rectangular flat resistive film layer members 10 (10A, 10B, 10C, and 10D). The resistive film layer member 10 has a configuration in which a resistive film layer 12 having a uniform film thickness is formed on one surface of a plate member 11 formed of an insulator such as alumina. Of course, the material of the plate member 11 is not limited to the alumina.

The resistive material of the resistive film layer 12 is also not particularly limited, but for example, metal-containing glass such as ITO (indium tin oxide), ruthenium oxide (RuO₂), or tantalum-silicon oxide (Ta—SiO₂), diamond like carbon (DLC), intrinsic carbon film (ICF), and the like can be used. Further, a method of forming the resistive film layer 12 is not particularly limited, but for example, any one of various existing methods such as a coating method including spraying and rotating, a vapor deposition method, a chemical method such as a wet process, and a sputtering method can be used.

Further, the plurality of resistive film layer members 10 may be formed by previously forming a resistor on the plate member 11 cut into the size of the resistive film layer member 10 or may be formed such that a resistor is formed on a surface of a plate member formed of an insulator having a larger size and the plate member is cut into the size of the resistive film layer member 10.

As illustrated in FIGS. 2 and 3, four resistive film layer members 10 of the same size are bonded to each other by using, for example, a silver fine particle sintered body 13 which is a conductive bonding member. By the adhesion using the silver fine particle sintered body 13, the entire inner surfaces of the rectangular cylindrical body having each of four surfaces respectively corresponding to four resistive film layer members 10 are coated with the resistive film layer 12 and the conductivity between the resistive film layers 12 of the surfaces is secured through the silver fine particle sintered body 13. As a result, the rectangular cylindrical resistive film layer 12 is formed on the inner surface of the drift cell 10.

Returning to the description of the entire ion mobility analyzer, as illustrated in FIG. 1, a grid-shaped shutter gate 4 is disposed at a predetermined position of an inner space of the drift cell 10 to be orthogonal to the center axis C, a region on the side of an ion source 1 in relation to the shutter gate 4 becomes the desolvation region 2, and a region on the side of the detector 5 becomes the drift region 3. A drift voltage generator 8 which is controlled by a controller 6 applies a predetermined voltage to each of both ends of the resistive film layer 12 of the inner surface of the drift cell 10. Further, a shutter voltage generator 7 which is controlled by the controller 6 applies a predetermined voltage to the shutter gate 4. Due to a difference in voltage applied to each of both ends of the resistive film layer 12, an electric field having a linear potential gradient is formed along the center axis C in the inner space of the rectangular cylindrical drift cell 10.

As described above, the resistive film layer 12 itself is formed in a rectangular cylindrical shape, but as a distance from the resistive film layer 12 in the direction of the center axis C increases, the shape of the equipotential line in the plane orthogonal to the center axis C becomes closer to a circle from a rectangle. For that reason, a substantially concentric cylindrical equipotential plane is formed in a predetermined space around the center axis C and the behavior of the ions does not substantially depend on the position in the circumferential direction.

That is, the drift region 3 is provided with a substantially ideal accelerating electric field with respect to ions drifting in the vicinity of the center axis C. Various ions introduced into the drift region 3 in a pulsed manner drift by the accelerating electric field while colliding with the diffusion gas which is going backward. In the process, each ion is separated in the traveling direction according to the ion mobility and reaches the detector 5.

As described above, the drift cell 10 is formed by bonding four flat resistive film layer members 10A, 10B, 10C, and 10D and the assembly process is very simple. Further, the step (operation) of forming the resistive film layer 12 on the surface of the flat plate member 11 is also much easier than the operation of forming the resistive film layer on the inner circumferential surface of the cylindrical glass tube as in the related art and the uniformity of the film thickness is easily secured. Thus, the accelerating electric field can be formed with high uniformity and high analysis accuracy and resolution can be secured while the drift cell 10 is formed at low cost.

Incidentally, in order to increase the uniformity of the electric field, electrodes formed as conductors such as metal may be provided at the ion incident side end portion and the ion emission side end portion of the drift cell 10 to contact the resistive film layers 12 of the resistive film layer members 10A, 10B, 10C, and 10D and a voltage may be applied from the drift voltage generator to the electrodes. Accordingly, a difference in potential depending on the position is eliminated at the resistive film layer 12 within a plane orthogonal to the center axis C and thus the uniformity of the electric field can be further improved.

In the above-described embodiment, the rectangular cylindrical drift cell 10 is formed by four flat resistive film layer members 10A to 10D, but the shape of the drift cell is not limited to the rectangular cylindrical shape. For example, a triangular cylindrical shape, a polygonal cylindrical shape, or the like may be used.

FIG. 4 is a cross-sectional view of a drift cell 20 according to another embodiment, but the drift cell 20 is formed in a star-shaped cylindrical shape by using ten flat resistive film layer members 20A, 20B, 20C, 20D, 20E, 20F, 20G, 20H, 20J, and 20K.

Further, the plurality of flat resistive film layer members may not be essentially formed in a flat plate shape. FIG. 5 is a cross-sectional view of a drift cell 30 according to still another embodiment. The drift cell 30 is formed by bonding two resistive film layer members 30A and 30B in which the resistive film layer 12 is formed on the inner surfaces of semi-circular cylindrical insulators obtained by cutting a cylindrical body into two parts in a plane including the axis.

In this way, when the resistive film layer member is formed in a non-flat plate shape, a method of forming a resistive film layer having a uniform film thickness is somewhat limited or a process becomes complicated compared to the case of forming a resistive film layer having a uniform thickness on a flat plate member. However, it is possible to form a resistive film layer having a uniform thickness with much simplicity and high accuracy compared to the case of forming a resistive film layer on the entire inner surface of the cylindrical member. Of course, a cylindrical drift tube may be formed by using a resistive film layer member having a circular-arc cross-sectional shape and obtained by cutting a cylindrical body into three or more parts in a plane including the axis.

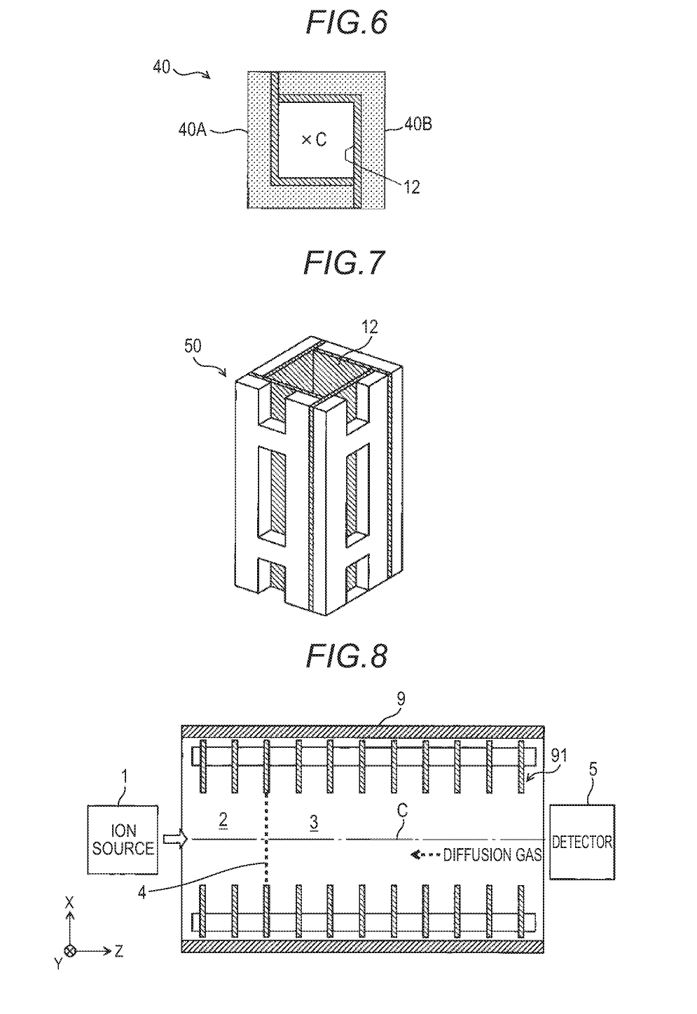

FIG. 6 is a cross-sectional view of a drift cell 40 according to still another embodiment. The drift cell 40 has the same rectangular cylindrical shape as the drift cell 10 illustrated in FIGS. 2 and 3 and is formed by bonding two resistive film layer members 40A and 40B in which the resistive film layer 12 is formed on two inner surfaces interposing a right angle corner of an L-shaped angled plate member.

Further, in all of the above-described embodiments, the resistive film layer is formed on the entire inner surface of the drift cell, but when the accelerating electric field suitable for moving ions is formed at the desolvation region 2 and the drift region 3, a part of the resistive film layer may be missed (eliminated).

Further, as in a drift cell 50 illustrated in the perspective view of FIG. 7, a part of the plate member 11 corresponding to an insulator may be eliminated while the cylindrical shape of the resistive film layer is kept. Specifically, for example, the drift cell may be formed by bonding the resistive film layer members in which a part of the plate member 11 is eliminated while the resistive film layer is left after the resistive film layer is formed on the entire one surface of the plate member. Alternatively, the drift cell may be formed by bonding the plurality of resistive film layer members as illustrated in FIG. 2 and a part of the plate member may be eliminated while the inner resistive film layer is left.

Further, in all of the above-described drift cells 10, 20, 30, 40, and 50, the cross-sectional areas in the center axis C are uniform, but may be formed so that the cross-sectional areas gradually increase in the ion traveling direction. For example, the cross-section may have a truncated pyramid cylindrical shape, a truncated conical cylindrical shape, or the like. However, in the case of such a shape, since the gas flow rate changes depending on the cross-sectional area of the drift cell even if a constant flow rate of a diffusion gas flows, there is a need to pay attention when estimating the collision cross-section between the ions and the diffusion gas based on the drift time.

The above-described embodiments are merely examples of the invention and the invention is not limited to the above-described embodiments and the above-described various modifications. Even when appropriate modifications, corrections, or additions are made within the scope of the gist of the invention, those are, of course, included in the scope of claims.

### REFERENCE SIGNS LIST

1 Ion source

2 Desolvation region

3 Drift region

4 Shutter gate

5 Detector

6 Controller

7 Shutter voltage generator

8 Drift voltage generator

10, 20, 30, 40, 50 Drift cell

10A, 10B, 10C, 10D, 20A, 20B, 20C, 20D, 20E, 20F, 20G, 20H, 20J, 20K, 30A, 30B, 40A, 40B Resistive film layer member

11 Plate member

12 Resistive film layer

13 Silver fine particle sintered body

C Center axis (ion optical axis)

1-4. (canceled)

5. An ion mobility analysis drift cell having a drift region, drifting ions by an accelerating electric field, formed therein, wherein the drift cell is formed by assembling a plurality of resistive film layer members in a cylindrical shape so that a resistive film layer faces an inner peripheral side using the plurality of resistive film layer members in which the resistive film layer is formed on a surface of an insulation plate member without a cylindrical closed portion.

6. The ion mobility analysis drift cell according to claim 5, wherein the drift cell is formed in a rectangular cylindrical shape or a truncated pyramid shape by assembling three or more resistive film layer members each forming one surface so that both ends are opened using the three or more resistive film layer members in which a resistive film layer is formed on the entirety or a part of at least one surface of a flat insulation plate member.

7. The ion mobility analysis drift cell according to claim 5,
wherein the drift cell is formed in a cylindrical shape or a truncated conical shape by assembling a plurality of resistive film layer members using the plurality of resistive film layer members in which a resistive film layer is formed on the entirety or a part of at least an inner peripheral surface of a curved insulation plate member having a shape obtained by cutting a cylindrical body or a truncated conical body into a plurality of parts in a plane including an axis thereof.

8. An ion mobility analyzer that uses the ion mobility analysis drift cell according to claim 5, comprising:
a) an ion source that generates ions derived from a sample;
b) a voltage generator that applies a predetermined voltage to both ends of a resistive film layer of an inner peripheral surface of the drift cell to form an accelerating electric field inside the cylindrical ion mobility analysis drift cell; and
c) a shutter gate that is disposed at an ion incident side end portion of the ion mobility analysis drift cell or an inner space of the drift cell and allows the passage of ions generated by the ion source only for a predetermined period to be sent to a drift region where the accelerating electric field is formed inside the drift cell,
wherein the ion mobility analyzer detects ions separated in response to ion mobility while passing through the drift region inside the ion mobility analysis drift cell or further sends the ions to a subsequent analysis and detection unit.

9. An ion mobility analyzer that uses the ion mobility analysis drift cell according to claim 6, comprising:
a) an ion source that generates ions derived from a sample;
b) a voltage generator that applies a predetermined voltage to both ends of a resistive film layer of an inner peripheral surface of the drift cell to form an accelerating electric field inside the cylindrical ion mobility analysis drift cell; and
c) a shutter gate that is disposed at an ion incident side end portion of the ion mobility analysis drift cell or an inner space of the drift cell and allows the passage of ions generated by the ion source only for a predetermined period to be sent to a drift region where the accelerating electric field is formed inside the drift cell,
wherein the ion mobility analyzer detects ions separated in response to ion mobility while passing through the drift region inside the ion mobility analysis drift cell or further sends the ions to a subsequent analysis and detection unit.

10. An ion mobility analyzer that uses the ion mobility analysis drift cell according to claim 7, comprising:
a) an ion source that generates ions derived from a sample;
b) a voltage generator that applies a predetermined voltage to both ends of a resistive film layer of an inner peripheral surface of the drift cell to form an accelerating electric field inside the cylindrical ion mobility analysis drift cell; and
c) a shutter gate that is disposed at an ion incident side end portion of the ion mobility analysis drift cell or an inner space of the drift cell and allows the passage of ions generated by the ion source only for a predetermined period to be sent to a drift region where the accelerating electric field is formed inside the drift cell,
wherein the ion mobility analyzer detects ions separated in response to ion mobility while passing through the drift region inside the ion mobility analysis drift cell or further sends the ions to a subsequent analysis and detection unit.
